(19) United States
(12) Patent Application Publication
(10) Pub. No.: US 2010/0326898 A1
(43) Pub. Date: Dec. 30, 2010

(54) Water filter with softener and residual hardness stabilizer

(75) Inventors: Roland Scholz, Balgach (CH); Bernd Heitele, Marbach (CH)

Correspondence Address: William D. Breneman, Esq.;BRENEMAN & GEORGES, 3150 Commonwealth Avenue, Alexandria, VA, 22305, US

(73) Assignee: AQUIS WASSER-LUFT-SYSTEME GMBH, LINDAU; Zweigniederlassung Rebstein, Rebstein (CH)

(21) Appl. No.: 12/801,752

(22) Filed: Jun. 23, 2010

(30) Foreign Application Priority Data
Jun. 25, 2009 (DE) 10 2009 030 669.2

(51) Int. Cl. C02F 5/00; C02F 1/42; C02F 5/08

(52) U.S. Cl. 210/232; 210/263; 210/282

(57) ABSTRACT

The present invention relates to a water filter for water-conveying equipment, in particular domestic appliances or appliances for preparing food and/or drinks such as automatic drinks machines, in particular automatic coffee machines, drinking water dispensers, cooking and baking appliances, steam appliances, in particular steam irons, steam cleaners, high pressure cleaners, air purifiers and air conditioners or the like, with a housing filled with filter material. The water filter is distinguished according to the invention in that a combination of a softener and a residual hardness stabilizer is provided as the filter material.

The present invention relates to a water filter according to the precharacterizing clause of claim 1.

### BACKGROUND OF THE INVENTION

To treat water, in particular in mains drinking water systems or water drawn therefrom and intermediately stored in containers, for example, it is known to exert influence on hardness constituents found therein. Conventional commercial water filters operate either according to the principle of separating hardness constituents, for example by ion exchange, or by inhibiting crystal growth, for example by adding inhibitors, as for example described in DE 10 2005 007 922 A1.

### OBJECT AND ADVANTAGES OF THE INVENTION

The object of the present invention is to improve water filters corresponding to the background of the invention explained above.

Taking the precharacterizing clause of claim 1 as basis, the object is achieved by the characterizing features of said claim.

The subclaims indicate convenient and advantageous further developments.

Accordingly the present invention relates to a water filter or water conditioner for water-conveying equipment, in particular domestic appliances or appliances for producing and preparing food and/or drinks such as automatic drinks machines, beverage dispensing systems, in particular automatic coffee machines, drinking water dispensers, ice cube makers, cooking and baking appliances, steam appliances, in particular steam irons, steam iron stations, steam cleaners, high pressure cleaners, air purifiers, humidifiers and air conditioners or the like, with a housing filled with water treatment material. This water filter is distinguished in that a combination of a softener and a residual hardness stabilizer is provided as the water treatment material.

By thus combining the two differently acting water treatment media for reducing or preventing hardness-related deposits on water-conveying equipment, on the one hand the two water treatment media may support one another's mode of action and on the other hand each medium may thereby at the same time relieve the pressure on the other medium, so extending the service life of both while providing substantially the same machine protection.

This interplay of the two water treatment media is particularly advantageous in the case of subsequent heating of the filtered water to high temperatures, e.g. >80° C., and/or in the case of elevated water hardnesses, e.g. of >10° German water hardness (dH). In such an instance, it may for example be sufficient for the softener to reduce the raw water merely to around 10° dH, instead of conventional reductions to for instance 4° to 6° dH, and for the residual hardness stabilizer, which may take effect from this hardness range, to have a stabilizing effect on the residual hardness and thus at least greatly reduce lime precipitation.

In a first embodiment, the softener may for example take the form of ion exchange filter material, for example in the form of an ion exchange resin. In a particularly preferred embodiment, the ion exchange filter material is hydrogen-bonded, such that it acidifies raw water on ion exchange by releasing hydrogen ions and may thus act as a pH value adjuster. This acidification-related change in pH value in turn adjusts the solubility equilibrium at least for calcium carbonate, such that the hydrogen-bonded ion exchange filter material active as an acidulant additionally reduces lime precipitation. Acidification by the hydrogen-bonded ion exchange material thus acts as a further residual hardness stabilizer.

Likewise, when producing ice in refrigerators, ice makers and ice cube machines, the production of stable, clear ice cubes is achieved by softening the water, in particular by an ion exchanger which is not sodium-exchanging but instead hydrogen-exchanging or by using physical mineral reducing methods. The interplay of softening with hardness stabilization has a particularly advantageous effect with regard to protecting ice-making machines from lime deposits and consequently improving energy efficiency. To produce clear, stable ice cubes, it may for example be sufficient for the softener to reduce the raw water merely to around 10° dH, instead of conventional reductions to for instance 0° to 4° dH, and for the residual hardness stabilizer, which may take effect from this hardness range, to have a stabilizing effect on the residual hardness and thus at least greatly reduce lime precipitation.

At least the first-mentioned residual hardness stabilizer, of primary importance according to the invention, may advantageously act as a sequestering agent for heavy metal ions, such as for example iron and manganese ions, and so bring about a reduction in and/or prevent corrosion and/or optionally also redissolve deposits which are already present.

If a phosphate compound, in particular a polyphosphate compound, is used as residual hardness stabilizer, a calcium-iron phosphate protective layer may advantageously be formed to reduce or prevent corrosion. More advantageously, it is thus also possible to prevent the otherwise corrosion-related occurrence of brown water.

In particular when using machine components consisting of materials of non-ferrous metals or non-ferrous metal alloys, the formation of a protective layer may be particularly advantageously effective in reducing or preventing corrosion.

In a further advantageous embodiment, a blending device may be provided for the filtered water, in which a non-softened water is admixed with the softened or partially softened water. In this way, on the one hand it is possible to establish more advantageously over a longer service period a filter action range or hardness range in the filtrate which is optimum for the particular application while at the same time protecting the downstream equipment from becoming furred up. On the other hand, it is thereby also possible to compensate deviations from this optimum filter action range at the start and towards the end of the filter's service life.

In a particularly preferred embodiment the blending device may be configured adjustably for this purpose. In this way a strong admixture of non-softened or otherwise treated raw water may for example be produced in the first operating period, in which the filter displays an initially powerful action. Once it has settled down to its operational action, it is then possible, by admixing a comparatively smaller amount of non-softened or otherwise treated raw water with the water softened or partially softened by the water filter, to take account of this change in filter action.

The filter's declining action at the end of the operating period of the water filter may correspondingly be taken into account by further reducing or optionally completely suspending the admixing of untreated or otherwise treated water with the raw water treated by the water filter.

Overall, a blending device, which for example comprises a bypass for channeling the non-softened raw water or an otherwise treated raw water past the softening or partial softening stage of the water filter with a means influencing the effective cross section thereof, may bring about a marked increase in the liter capacity in comparison with a water filter which is not equipped with such a bypass or a corresponding blending device.

In this case, it is particularly advantageous for the means influencing blending to set or adjust the effective cross section for the bypass and/or filtrate water as a function of the degree of exhaustion of the ion exchanger used.

It is moreover also possible, with the combination provided according to the invention of a filter material, consisting of a softener and a residual hardness stabilizer, to bring about a corresponding increase in the liter capacity of a water filter with bypass in comparison with a water filter with just a softener or a residual hardness stabilizer.

In the event of the use in particular of machine components consisting of materials of non-ferrous metal or non-ferrous metal alloys, it is possible, as a result of the higher blend content which is possible compared to a water filter with just a softener or a residual hardness stabilizer, to keep the filtrate at a relatively high pH value and additionally to reduce or prevent corrosion.

In a further preferred embodiment, an activated carbon filter may also be provided, with which it is possible for example to bring about an improvement in flavor and/or the filtering of questionable or harmful substances out of the raw water to be filtered.

The constructional design of such a water filter may in one possible embodiment advantageously be such that it takes the form of a filter cartridge insertable into a water tank. Such a water tank may for example be a water storage tank for a water-conveying apparatus, in particular a domestic appliance.

Alternatively or additionally, the water filter may be configured such that it takes the form of a filter cartridge insertable into an in-line filter head. An in-line filter head is understood according to the invention to mean all filter fittings which may be connected to a water-conveying line, in particular to a domestic mains water supply system, or integrated therein.

### EXEMPLARY EMBODIMENT

The present invention is illustrated in greater detail below with reference to the attached figures, in which:

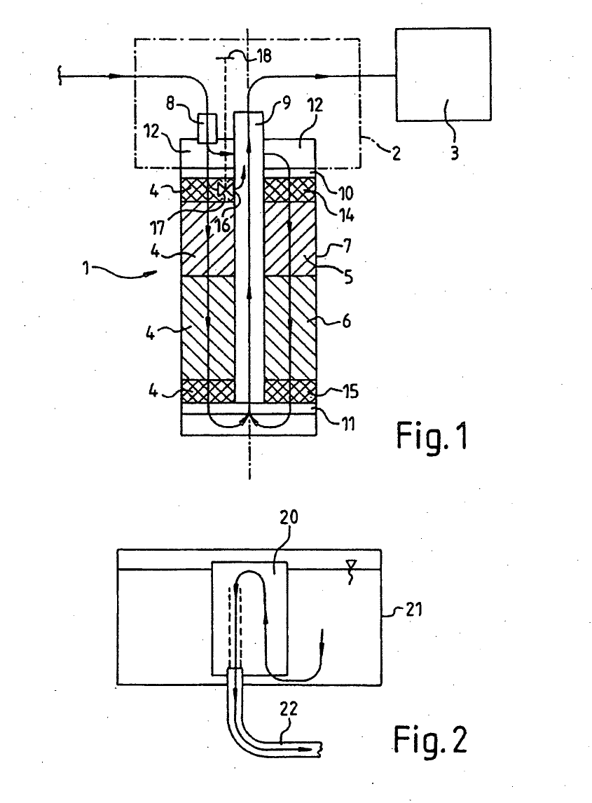

FIG. 1 shows a schematic, perspective sectional representation of a water filter with softener and residual hardness stabilizer, connected by way of example to an in-line filter head and a domestic machine connected therewith;

FIG. 2 shows an exemplary embodiment modified relative to FIG. 1.

FIG. 1 accordingly shows schematically by way of example a water filter 1, which is connected to an in-line filter head 2 and via which a water-conveying apparatus 3 is supplied with appropriately treated water.

The filter material 4 consists of a combination of a softener 5, e.g. an ion exchanger in the form of a resin, and a residual hardness stabilizer 6, for example in the form of a phosphate compound, particularly preferably in the form of a polyphosphate compound.

So that the filter material introduced into the housing 7 cannot escape into the inlet 8 or the outlet 9, retaining means 10, 11 may additionally be provided, when viewed in the flow direction. These may take the form, for example, of a screen, a nonwoven or the like.

To achieve favorable inflow behavior, it is for example additionally possible to provide a feed chamber 12 in the form for example of an annular chamber, by which the water flowing in through the inlet 8 may be evenly admitted to the filter material on the filter entrance side.

By analogy, an outflow chamber 13 may correspondingly be provided for the filter outflow on the filter outlet side.

An activated carbon filter 14 may be provided on the filter inlet side, for example for improving flavor and/or for filtering out any undesirable water constituents which may be present. A further activated carbon filter may be provided for example on the filter outlet side to improve further the filter action.

A blending device 16 for admixing untreated or otherwise treated raw water with the raw water treated by the filter material 5, 6 may on the one hand may contribute to increasing the liter capacity of the water filter 1 and on the other hand achieves an extension in the operating period for which the water filter operates optimally, i.e. exhibits the filter action desired thereof.

An adjusting means 17, e.g. in the form of a valve, an orifice of influenceable cross section or the like advantageously enables adjustment of the blending device. To operate this adjusting means, a controlling element 18 may be provided, for example in the form of a slider, a pivot pin, optionally with thread-guided adjustment or the like.

To simplify the illustration, the water filter shown in FIG. 1 is shown in the form of a filter cartridge connectable to a filter head 2 and configured approximately cylindrically about the axis 19. Other contours of the housing and/or the other filter components are also entirely feasible, however, such as for example oval or polygonal cross sectional shapes. Spherical filter contours are also entirely possible.

FIG. 2 shows an embodiment of a water filter 20 modified relative to FIG. 1 to the effect that it is configured to be connectable to a tank 21 and is arranged therein.

The filter bed of the water filter may take the form, in both embodiments, of either an upflow or a downflow and/or a combined up- and downflow filter bed. The outlet 22 shown by way of example in FIG. 2 may lead for example to a corresponding, water-conveying apparatus, which is supplied with the water purified by the filter 20.

### LIST OF REFERENCE NUMERALS

1 Water filter
2 Filter head
3 Water-conveying apparatus
4 Filter material
5 Softener
6 Residual hardness stabilizer
7 Housing
8 Inlet
9 Outlet
10 Retaining means
11 Retaining means
12 Feed chamber
13 Outflow chamber
14 Activated carbon filter
15 Activated carbon filter
16 Blending device
17 Adjusting means
18 Actuator
19 Axis
20 Water filter
21 Tank
22 Outlet

What is claimed is:

1. Water filter for water-conveying equipment, in particular domestic appliances or appliances for producing and preparing food and/or drinks such as automatic drinks machines, in particular automatic coffee machines, drinking water dispensers, ice cube makers, refrigerators, cooking and baking appliances, steam appliances, in particular steam iron systems, steam cleaners, high pressure cleaners, air purifiers, humidifiers and air conditioners or the like, with a housing filled with water treatment material, characterized in that a combination of a softener and a residual hardness stabilizer is provided as the water treatment material.

2. Water filter according to claim 1, characterized in that an ion exchange filter material is provided as the softener.

3. Water filter according to claim 1 or 2, characterized in that a predominantly hydrogen-bonded ion exchange filter material is provided.

4. Water filter according to one of the preceding claims, characterized in that a weakly acidic cation exchanger is provided as the softener.

5. Water filter according to one of the preceding claims, characterized in that the ion exchange filter material is a pH value adjuster.

6. Water filter according to one of the preceding claims, characterized in that the ion exchange filter material is an acidulant.

7. Water filter according to one of the preceding claims, characterized in that a sequestering agent is provided as the residual hardness stabilizer.

8. Water filter according to one of the preceding claims, characterized in that a phosphate compound is provided as the residual hardness stabilizer.

9. Water filter according to one of the preceding claims, characterized in that the phosphate compound is a polyphosphate compound.

10. Water filter according to one of the preceding claims, characterized in that the ion exchange filter material is an additional residual hardness stabilizer.

11. Water filter according to one of the preceding claims, characterized in that a blending device is provided for the water to be filtered.

12. Water filter according to one of the preceding claims, characterized in that the blending device is adjustably configured.

13. Water filter according to one of the preceding claims, characterized in that a blending device is installed in the filter, which modifies or adjusts the blending as a function of the degree of exhaustion of the filter material.

14. Water filter according to one of the preceding claims, characterized in that an activated carbon filter is provided.

15. Water filter according to one of the preceding claims, characterized in that the water filter takes the form of a filter cartridge insertable into a tank.

16. Water filter according to one of the preceding claims, characterized in that the water filter takes the form of a filter cartridge insertable into an in-line filter head.

17. Water filter according to one of the preceding claims, characterized in that it is used in a tank, a suction connection being provided on the tank for drawing water out of the water tank, with means for producing a reduced pressure, and a filter connection being provided for connecting the water filter to the inside of the tank.
